(19) United States
(12) Patent Application Publication
(10) Pub. No.: US 2011/0091341 A1
(43) Pub. Date: Apr. 21, 2011

(54) METHOD AND APPARATUS FOR ESTABLISHING CLEARANCES IN SCROLL COMPRESSOR

(76) Inventors: Carlos Zamudio, Lyon (FR); Edward A. Tomayko, Arkadelphia, AR (US); Joe T. Hill, Arkadelphia, AR (US); Tracy L. Milliff, Arkadelphia, AR (US); Zili Sun, Arkadelphia, AR (US); Gene M. Fields, Arkadelphia, AR (US); Gregory W. Hahn, Arkadelphia, AR (US); John R. Williams, Bristol, VA (US); Thomas R. Barito, Arkadelphia, AR (US)

(21) Appl. No.: 12/582,936

(22) Filed: Oct. 21, 2009

(51) Int. Cl. F04C 2/02; B23P 11/00

(52) U.S. Cl. 418/55.1; 29/888.022

(57) ABSTRACT

A scroll compressor is provided having appropriate clearance for movement of the orbiting scroll member. Clearance is provided without requiring contact between the crankcase, which supports the orbiting scroll, and the non-orbiting scroll member. Clearance is established during the assembly process using installation tooling that establishes locations of components using a reference point. Clearance is also established using spacers.

### BACKGROUND OF THE INVENTION

This application relates to properly positioning a scroll compressor crankcase and a non-orbiting scroll. Appropriate axial clearances are maintained to ensure efficient operation of the scroll compressor.

Scroll compressors have become widely utilized in refrigerant compression applications. In a typical scroll compressor, a first scroll member includes a base with a generally spiral wrap extending from the base. A second scroll member also has a base and a generally spiral wrap extending from its base. The two wraps interfit to define compression chambers. One of the two scroll members is caused to orbit relative to the other, and as they orbit, the size of the compression chambers is decreased, compressing an entrapped refrigerant.

A separating force is created by the compressed refrigerant that tends to push the two scroll members away from each other. To entrap and define a compression chamber, the wrap of each scroll member must be in contact with the base of the other scroll member. The separating force tends to move the wraps out of engagement, and thus prevents compression. The orbiting scroll member rests on a crankcase within the scroll compressor. The crankcase holds the orbiting scroll member in position against the non-orbiting scroll member.

One challenge with scroll compressors is that the crankcase must maintain a critical axial clearance with the non-orbiting scroll member. In so doing, the crankcase and non-orbiting scroll member provide appropriate clearance for movement of the orbiting scroll member. To maintain the appropriate clearance, some crankcases include towers, which extend past the orbiting scroll member to contact the non-orbiting scroll member. These towers are often difficult to cast and machine. Further, providing packaging area for the towers constrains the size and design of other compressor components. It would be desirable to maintain appropriate clearance for the orbiting scroll member without using crankcase towers.

### SUMMARY OF THE INVENTION

In a disclosed embodiment of this invention, a non-orbiting scroll member is secured to a compressor center shell and provides appropriate clearance for movement of an orbiting scroll member. A crankcase supports the orbiting scroll member, but the crankcase does not extend to contact the non-orbiting scroll member. Instead, the position of crankcase relative to the non orbiting scroll member is controlled using structural locators or spacers.

The present invention thus provides a method for maintaining adequate clearance for orbiting scroll member movement without relying on contact between the crankcase and the non-orbiting scroll member.

Features of this invention include controlling the installed position of the crankcase within a compressor center shell using a structural locator. Press tooling is typically used to install the crankcase within the compressor center shell. During assembly, the press tooling establishes the installed position of the crankcase based on the location of the structural locator. In one example, a step, a type of structural locator, on the press tooling contacts an edge of the compressor center shell to limit installation of the crankcase. As the non-orbiting scroll member attaches to the edge, appropriate clearances are maintained.

In another example, the compressor center shell includes a step for limiting installation of the crankcase. The position of the step within the compressor shell is based on the location of the edge of the compressor center shell. The step may be machined together with the edge of the compressor center shell. As the non-orbiting scroll member attaches to the edge, appropriate clearances are maintained.

Spacers may be used to position the crankcase relative to the non-orbiting scroll member. A spacer, such as a ring, positioned between the crankcase and the non-orbiting scroll member may force the crankcase into position as the non-orbiting scroll member is installed. Similarly, extensions on at least one of the crankcase, the orbiting scroll member or the non-orbiting scroll member may establish appropriate clearances. In such examples, frictional contact wears the extensions, and, after sufficient movement of the orbiting scroll member, appropriate clearance remains.

These and other features of the present invention can be best understood from the following specification and drawings, the following of which is a brief description.

### BRIEF DESCRIPTION OF THE DRAWINGS

FIG. 1 shows a portion of a prior art scroll compressor structure.

FIG. 2 shows a portion of the scroll compressor structure with a clearance.

FIG. 3 is a close-up view of area A of FIG. 2 during assembly depicting an embodiment for maintaining the clearance.

FIG. 4 is a close-up view of area A of FIG. 2 depicting an alternative embodiment for maintaining the clearance.

FIG. 5 is a close-up view of area A of FIG. 2 depicting another alternative embodiment for maintaining the clearance.

FIG. 6 is a close-up view of area A of FIG. 2 depicting another alternative embodiment for maintaining the clearance.

### DETAILED DESCRIPTION OF THE PREFERRED EMBODIMENT

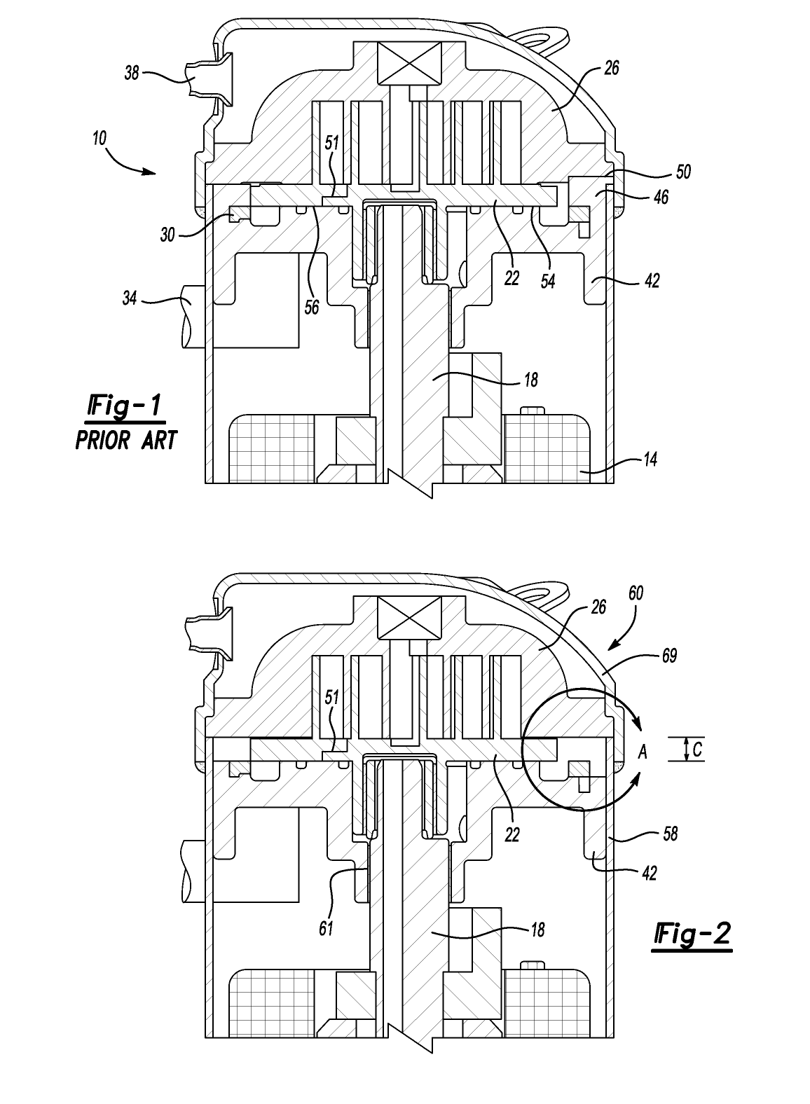

A scroll compressor 10 is illustrated in FIG. 1. As known, a motor 14 is provided to drive a shaft 18. An orbiting scroll member 22 is driven by the shaft 18 to orbit relative to a non-orbiting scroll member 26. An Oldham coupling 30 converts the rotation of the shaft 18 to orbiting movement of the orbiting scroll member 22. As also known, a suction port 34 allows refrigerant to enter the compressor 10, and a discharge port 38 delivers compressed refrigerant to a downstream user, such as a condenser in a refrigeration system.

A crankcase 42 supports the orbiting scroll member 22. A tower portion 46 of the crankcase 42 contacts the non-orbiting scroll member 26. In so doing, the tower portion 46 maintains adequate clearance between the crankcase 42 and the non-orbiting scroll member 26, which enables movement of the orbiting scroll member 22. The amount of clearance depends on the location of a tower face 50 contacting the non-orbiting scroll member 26 relative to the location of a crankcase face 54 supporting the orbiting scroll member 22. A back pressure chamber 56 biases the orbiting scroll member 22 toward the non-orbiting scroll member 26. A tap 51 taps compressed refrigerant into chamber 56.

The present invention does not rely on the tower portions 46 to maintain clearance for movement of the orbiting scroll member 22. Instead, as shown in FIG. 2, a compressor 60 of the present invention utilizes alternative ways of establishing an appropriate clearance. Such clearances include axial clearances of the crankcase 42 relative to the non-orbiting scroll member 26, as well as axial alignment of at least one bearing 61 supporting the shaft 18.

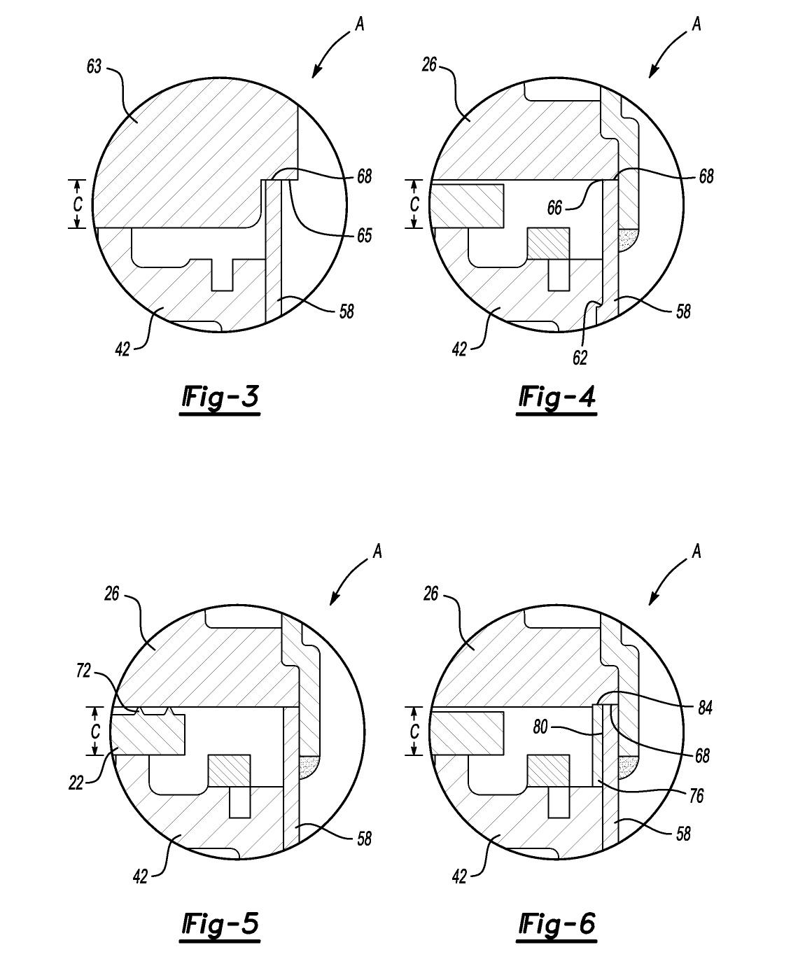

For example, FIG. 3 shows a close up view of area A of portions of the compressor 60 in FIG. 2 during assembly. In this example, the diameter of the crankcase 42 at some locations is slightly larger than an inside dimension of the compressor center shell 58. As a result, interference between the crankcase 42 and the compressor center shell 58 holds the crankcase 42 in position once installed.

As is known, to assemble the crankcase 42 within the compressor center shell 58, press tooling 63 forces the crankcase 42 into the compressor center shell 58. In one example of the present invention, the press tooling 63 includes a structural locator 65 for contacting an edge portion 68 of the compressor center shell 58 to establish the appropriate installed position of the crankcase 42. Contact between the structural locator 65 and the edge portion 68 prevents the press tooling 63 from installing the crankcase 42 further into the compressor center shell 58. The structural locator 65 thereby physically prevents installation of the crankcase 42 further into the compressor center shell 58.

Once positioned within the compressor center shell 58, interference between the crankcase 42 and the compressor center shell 58 holds the crankcase 42 in position, and the press tooling 63 may be removed. Next, the non-orbiting scroll member 26 is secured in position using a compressor top shell 69 welded to the compressor center shell 58 (FIG. 2). Once located, the non-orbiting scroll member 26 directly contacts the edge portion 68. Thus, the crankcase 42 position depends on the edge portion 68, and the non-orbiting scroll member 26 secures directly to the edge portion 68. Adequate clearance C between the non-orbiting scroll member 26 and the crankcase 42 is ensured as both are positioned and secured based on the edge portion 68. In this example, the structural locator 65 is a notch, however, a person skilled in the art and having the benefit of this disclosure may recognize other suitable structural locators capable of preventing further installation of the crankcase 42 based on contact between the structural locator and the edge portion 68.

FIG. 4 illustrates an example where a step 62 in the compressor center shell 58 establishes a stop position for locating the crankcase 42 during installation. In this example, the structural locator is located on the compressor center shell 58 rather than on the press tooling. The step 62 prevents further installation of the crankcase 42 into the compressor center shell 58, and interference between the crankcase 42 and the compressor center shell 58 prevents the crankcase 42 from moving away from the step 62. Thus, the step 62 acts as a stop during installation and establishes the position of the crankcase 42 within the compressor center shell 58.

The position of the step 62 is established based on a reference point 66, which is typically located near, or at, edge portion 68 of the compressor center shell 58. Tooling that forms the compressor center shell 58, and more specifically the edge portion 68 of the compressor center shell 58, also forms the step 62. Thus, a relationship between the step 62 and the reference point 66 is established when tooling the edge portion 68 of the compressor center shell 58. During assembly of the compressor 60, the non-orbiting scroll member 26 directly connects to the compressor center shell 58 at edge portion 68, which includes reference point 66. As a result, the step 62 position directly relates to position of the reference point 66 and the edge portion 68 thereby establishing an appropriate clearance between the two.

FIG. 3 and FIG. 4 illustrate examples that establish appropriate clearance using the edge portion 68 of the compressor center shell 58. Those skilled in the art may understand that multiple locations and reference points 66 may be used to establish appropriate clearance. Further, the reference point 66 may be located away from the edge portion 68, provided the position of the non-orbiting scroll member 26 is established based on where the non-orbiting scroll member 26 contacts the compressor center shell 58.

In another example, clearance C is establish using spacers 72 located on the orbiting scroll member 22, as shown in FIG. 5. The spacers 72 are small extensions or nubs on the orbiting scroll member 22, which wear after the orbiting scroll member 22 begins to move relative to the non-orbiting scroll member 26. During installation, the non-orbiting scroll member 26 directly contacts the spacers 72, and the crankcase 42 contacts the orbiting scroll member 22 to establish an appropriate clearance C. After securing the non-orbiting scroll member 26 to the compressor center shell 58, the spacers 72 are no longer required as both the non-orbiting scroll member 26 and the crankcase 42 are appropriately secured. Frictional contact between the spacers 72 and the non-orbiting scroll member 26 wears away the spacers 72. After sufficient orbital cycles, the spacers 72 are worn away leaving the orbiting scroll member 22 having an appropriate clearance C for operation.

Although in this example the spacers 72 are shown as a portion of the orbiting scroll member 22, other spacer locations are possible. For example, locating the spacers 72 on the crankcase 42 or the non-orbiting scroll member 26 may provide similar advantages.

FIG. 6 depicts another example embodiment. In this example, a ring 76 establishes clearance between the crankcase 42 and the non-orbiting scroll member 26. After partially installing the crankcase 42 within the compressor center shell 58, the ring 76 is placed on the crankcase 42 proximate the inside edge 80 of the compressor center shell 58. The non-orbiting scroll member 26 is then secured to the compressor center shell 58 and radially locates to a leading edge 84 of the ring 76. The forces used to secure the non-orbiting scroll member 26 in position transfer through the ring 76 to the crankcase 42 and force the crankcase 42 from a partially installed position to an installed position. Once the non-orbiting scroll member 26 contacts the edge portion 68 of the compressor center shell 58, the ring 46 no longer moves the crankcase 42. The ring 76 also locates the non-orbiting scroll member 26 for installation as the ring 76 prevents substantial radial movement of the non-orbiting scroll member 26.

In this example, the ring 76 is a thin ring having an axial thickness of less than 1.0 mm. Many ring 76 materials are possible, provided the material is capable of forcing the crankcase 42 into an installed position. For example, steel or plastic rings may be used.

Although a preferred embodiment of this invention has been disclosed, a worker of ordinary skill in this art and having the benefit of this disclosure may recognize other modifications that would come within the scope of this invention. For that reason, the following claims should be studied to determine the true scope of coverage for this invention.

What is claimed is:

1) A method of assembling a scroll compressor, comprising:
(a) establishing a reference point on a compressor center shell;
(b) determining a position for a support based on the reference point, the support operative to support a first scroll member;
(c) determining a position for a second scroll member based on the reference point, wherein at least a portion of the second scroll member is located apart from the support.

2) The method of claim 1, including the step of:
(d) installing the support within the compressor center shell using press tooling.

3) The method of claim 2, including the step of:
(e) limiting of said step (d) using a structural locator.

4) The method of claim 3, wherein the structural locator is a notch located on the press tooling which stops movement of the support once the notch contacts a surface on the compressor center shell.

5) The method of claim 3, wherein the structural locator is a notch located on the compressor center shell which stops movement of the support once the support contacts the notch.

6) The method of claim 5, including the step of machining the notch together with a parallel surface of the compressor center shell, the parallel surface providing a positioning point for the second scroll member.

7) The method of claim 1, including the step of:
(d) installing the support within the compressor center shell using a spacer.

8) The method of claim 7, wherein the spacer is a ring.

9) The method of claim 7, wherein the spacer is an extension of at least one of the support, the first scroll member, or the second scroll member.

10) The method of claim 1, wherein the reference point is located on a portion of the compressor center shell.

11) A scroll compressor, comprising:
a first scroll member secured adjacent a compressor center shell;
a support structure secured within said compressor center shell and apart from said first scroll member;
a second scroll member supported by said support structure and at least partially disposed between said first scroll member and said support structure; and
at least one spacer establishing a spatial relationship between said support structure and said first scroll member.

12) The scroll compressor of claim 11, wherein said spacer is a ring spacer.

13) The scroll compressor of claim 12, wherein said ring spacer abuts an interior surface of said compressor center shell.

14) The scroll compressor of claim 11, wherein said spacer radially locates said first scroll member.

15) The scroll compressor of claim 11, wherein said spacer contacts said support structure to position said support structure within said compressor center shell.

16) The scroll compressor of claim 11, wherein said spacer is an extension of at least one of said support structure, said first scroll member, or said second scroll member.

17) The scroll compressor of claim 16, wherein frictional contact wears said extension.

18) A scroll compressor, comprising:
a first scroll member secured adjacent a compressor center shell;
a support structure secured within said compressor center shell and apart from said first scroll member;
a second scroll member supported by said support structure and at least partially disposed between said first scroll member and said support structure; and
at least one structural locator establishing a spatial relationship between said support structure and said first scroll member.

19) The scroll compressor of claim 18, wherein said structural locator is a notch within said compressor center shell.

20) The scroll compressor of claim 18, wherein said structural locator limits movement of said support structure in at least one direction.
